(19) United States
(12) Patent Application Publication
(10) Pub. No.: US 2018/0106332 A1
(43) Pub. Date: Apr. 19, 2018

(54) SIX-SPEED DOUBLE CLUTCH TRANSMISSION FOR VEHICLE

(71) Applicants: Hyundai Motor Company, Seoul (KR); Kia Motors Corporation, Seoul (KR)

(72) Inventors: Sueng-Ho LEE, Seoul (KR); Kyeong-Hun LEE, Seoul (KR); Seong-Wook HWANG, Gunpo-si (KR); Ki-Dong KIM, Anyang-si (KR); Ji-Hun LEE, Seoul (KR); Ma-Ru KANG, Yongin-si (KR); Il-Han YOO, Hwaseong-si (KR); Soon-Ki EO, Ansan-si (KR); Yong-Seok CHOI, Hwaseong-si (KR); Chon-Ok KIM, Yongin-si (KR)

(73) Assignees: Hyundai Motor Company, Seoul (KR); Kia Motors Corporation, Seoul (KR)

(21) Appl. No.: 15/695,820

(22) Filed: Sep. 5, 2017

(30) Foreign Application Priority Data
Oct. 17, 2016 (KR) 10-2016-0134158

(51) Int. Cl. F16H 3/091; F16H 61/684; B60K 6/547; B60K 6/36; B60W 20/30; F16H 3/00

(52) U.S. Cl. CPC F16H 3/0915; F16H 61/684; B60K 6/547; B60W 10/113; B60W 20/30; F16H 3/006; B60K 6/36

(57) ABSTRACT

A six-speed includes first and second input shafts and on which drive gears are disposed, an idler shaft on which idler drive gears are disposed, and first and second output shafts on which driven gears are disposed. The whole length of the DCT is formed such that an upper whole length section is reduced by the length of a second output shaft that is reduced by disposing the sixth-speed and reverse driven gears on the second output shaft, or an intermediate whole length section formed between the upper and lower whole length sections is reduced by the length of the first input shaft that is reduced by disposing the fifth-, sixth- and reverse driven gears on the second output shaft.

### CROSS-REFERENCE(S) TO RELATED APPLICATIONS

The present application claims priority to Korean Patent Application No. 10-2016-0134158, filed on Oct. 17, 2016, the entire contents of which is incorporated herein for all purposes by this reference.

### BACKGROUND OF THE INVENTION

### Field of the Invention

Exemplary embodiments of the present invention relate to a six-speed double clutch transmission for a vehicle; and, particularly, to a six-speed double clutch transmission for a vehicle which is able to achieve an ease of disposition for a small vehicle or a hybrid vehicle.

### Description of Related art

In general, a double clutch transmission (DCT) has the advantage of achieving both the excellent power transmission efficiency of a manual transmission (MT) and the convenience in use of an automatic transmission (AT).

Accordingly, the field use of the DCT has been limited to a transmission for a high performance vehicle or a high-class vehicle, but is expanding to a small vehicle or a hybrid vehicle.

Referring to FIG. 11, there is illustrated an example in which a small DCT for a small vehicle or hybrid vehicle is embodied by a six-speed DCT.

As shown in the drawing, the small DCT includes two input shafts (Input Shaft #1 and Input Shaft #2), two output shafts (Output Shaft #1 and Output Shaft #2), and two clutches (Clutch #1 and Clutch #2). The whole length of the DCT is divided into a lower whole length section L_{lower} defined by a combination of 1st, 2nd, 3rd, and 4th gears and the output shaft #1, and an upper whole length section Lᵤₚₚₑᵣ defined by a combination of 5th, 6th and reverse (Rev) gears and the output shaft #2. Consequently, an ease of disposition for a small vehicle or hybrid vehicle can be achieved.

However, in the case of the small DCT, there is a difficulty in designing a gear train layout reflecting a step ratio (a lower-speed gear ratio to a higher-speed gear ratio when each gear stage is shifted to another gear stage) which affects the drivability.

The reason for the present issue is because, as shown in FIG. 11, the first speed must be embodied through the use of a common gear (used as a winding path) of first speed and second speed using a fourth- and sixth-speed gear. The present case puts the step ratios of first speed, second speed and third speed at a disadvantage and thus has a negative effect on the drivability.

Above all, since the small DCT needs a gear train layout for forming a forward gear stage, there is a limit in reducing the upper whole length section Lᵤₚₚₑᵣ which greatly affects the ease of disposition of elements in a vehicle.

For example, with regard to the upper whole length section Lᵤₚₚₑᵣ of FIG. 11, since the Rev gear of the output shaft #2 is formed along with the fifth and sixth gears for forming the forward gear stages, the shaft length of the output shaft #2 is increased. An increase in length of the output shaft #2 increases the upper whole length section Lᵤₚₚₑᵣ. As a result, when the length of a motor for application of a hybrid structure is added, it may be impossible to dispose the DCT in spite of the small DCT.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a six-speed double clutch transmission in which a plurality of idler gears are used so that a forward gear stage is not formed in an upper whole length section, whereby the whole length of the DCT is reduced and the idler gears can be used as first- and second-speed winding paths so that the step ratio is enhanced, thus improving ease of disposition for a small vehicle or a hybrid vehicle, reducing influence of the step ratio on the drivability, and making it possible to form a gear train layout without using a first-speed gear.

Other aspects and advantages of the present invention may be understood by the following description and is apparent with reference to the embodiments of the present invention. Also, it is obvious to those skilled in the art to which the present invention pertains that the aspects and advantages of the present invention may be realized by the means as claimed and combinations thereof.

The exemplary embodiment of the present invention is directed to provide a six-speed double clutch transmission including an input element from a power source, a first clutch and a second clutch, a first input shaft and a second input shaft each functioning as an input element of the transmission, and a first output shaft, a second output shaft and an idler shaft each functioning as an output element of the transmission. The first input shaft and second input shaft are coaxially disposed, the first input shaft is selectively coupled to the input element through the first clutch, and the second input shaft is selectively coupled to the input element through the second clutch. One or more drive gears are disposed on each of the first input shaft and the second input shaft, one or more driven gears are disposed on each of the first output shaft and the second output shaft, and one of the drive gears and one of the corresponding driven gears are continuously-connected to each other through external engagement to form a gear pair, and transmit drive force of the input element to a drive shaft of a vehicle through a plurality of gear shifting devices, thus embodying a forward gear shift stage. One drive gear disposed on the first input shaft externally engages with one driven gear disposed on the idler shaft, thus forming a continuously-connected gear pair. The one driven gear is selectively coupled to one or more drive gears disposed on the idler shaft through a separate gear shifting device. One drive gear disposed on the idler shaft externally engages with one drive gear disposed on the second input shaft, thus forming a continuously-connected gear pair, and the drive force from another drive gear disposed on the second input shaft is transmitted to the drive shaft of the vehicle, thus embodying another forward gear shift stage.

The first input shaft may be a solid shaft, and the second input shaft may be a hollow shaft.

The drive gears of the first input shaft and the second input shaft may include a second-speed drive gear, a third-speed drive gear, a fourth- and sixth-speed drive gear, and a fifth-speed drive gear. The driven gears of the first output shaft and the second output shaft may include a second-speed driven gear, a third-speed driven gear, a fourth-speed driven gear, a fifth-speed driven gear, a sixth-speed driven gear, and a reverse driven gear. The driven gear on the idler shaft may include a second idler gear, and the drive gears on the idler shaft may include a first idler gear and a third idler gear. The gear shifting devices may include a third- and fifth-speed gear shifting device, a two- and fourth-speed gear shifting device, a sixth- and reverse gear shifting device, and a first-speed gear shifting device.

The drive gears of the first input shaft and the second input shaft may include a second-speed drive gear, a third-speed drive gear, a fourth- and sixth-speed drive gear, and a fifth-speed drive gear. The driven gears of the first output shaft and the second output shaft may include a second-speed driven gear, a third-speed driven gear, a fourth-speed driven gear, a fifth-speed driven gear, a sixth-speed driven gear, and a reverse driven gear. The driven gear on the idler shaft may include a second idler gear, and the drive gears on the idler shaft may include a first idler gear and a third idler gear. The gear shifting devices may include a third-speed gear shifting device, a two- and fourth-speed gear shifting device, a sixth-speed and reverse gear shifting device, a first-speed gear shifting device, and a fifth-speed gear shifting device.

The methods and apparatuses of the present invention have other features and advantages which will be apparent from or are set forth in more detail in the accompanying drawings, which are incorporated herein, and the following Detailed Description, which together server to explain certain principles of the present invention.

### BRIEF DESCRIPTION OF THE DRAWINGS

FIG. 1 illustrates a layout of a gear train of a first type six-speed DCT applied to a hybrid vehicle according to an exemplary embodiment of the present invention.

FIG. 2 is a table depicting a gear shifting operation of the first type six-speed DCT according to an exemplary embodiment of the present invention.

FIG. 3 is a view depicting a power transmission path of a first-gear stage shifting operation in the first type six-speed DCT according to an exemplary embodiment of the present invention.

FIG. 4 is a view depicting a power transmission path of a forward-gear stage shifting operation in the first type six-speed DCT according to an exemplary embodiment of the present invention.

FIG. 5 is a view depicting a power transmission path of a reverse-gear shifting operation in the first type six-speed DCT according to an exemplary embodiment of the present invention.

FIG. 6 illustrates a layout of a gear train of a second type six-speed DCT applied to a hybrid vehicle according to an exemplary embodiment of the present invention.

FIG. 7 is a table depicting a gear shifting operation of the second type six-speed DCT according to an exemplary embodiment of the present invention.

FIG. 8 is a view depicting a power transmission path of a first-gear stage shifting operation in the second type six-speed DCT according to an exemplary embodiment of the present invention.

FIG. 9 is a view depicting a power transmission path of a forward-gear stage shifting operation in the second type six-speed DCT according to an exemplary embodiment of the present invention.

FIG. 10 is a view depicting a power transmission path of a reverse-gear stage shifting operation in the second type six-speed DCT according to an exemplary embodiment of the present invention.

FIG. 11 is an example of a six-speed DCT for a small vehicle or hybrid vehicle according to a conventional art.

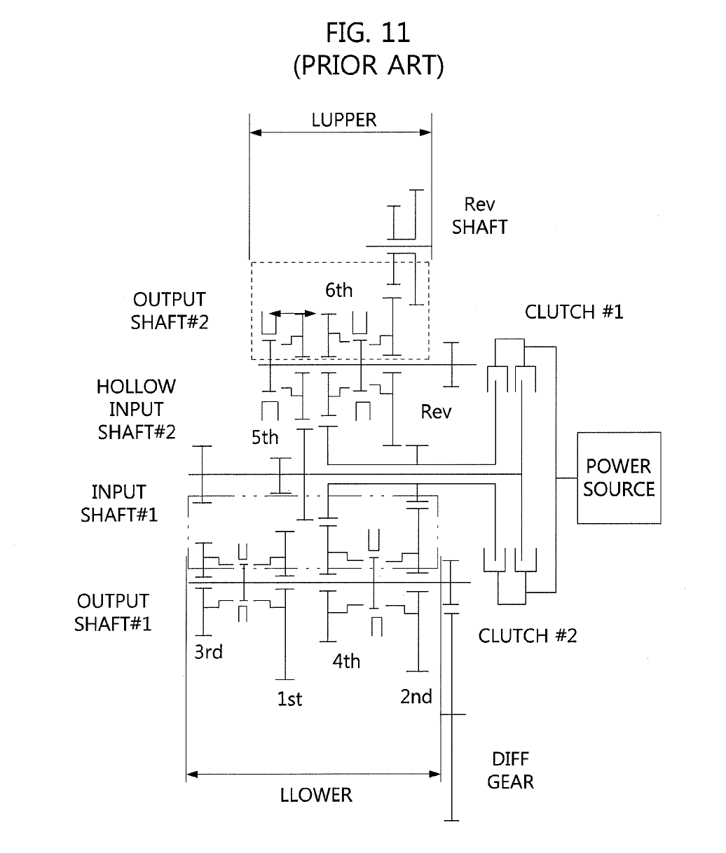

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to convey not only the exemplary embodiments, but also various alternatives, modifications, equivalents and other embodiments, which may be included within the spirit and scope of the invention as defined by the appended claims.

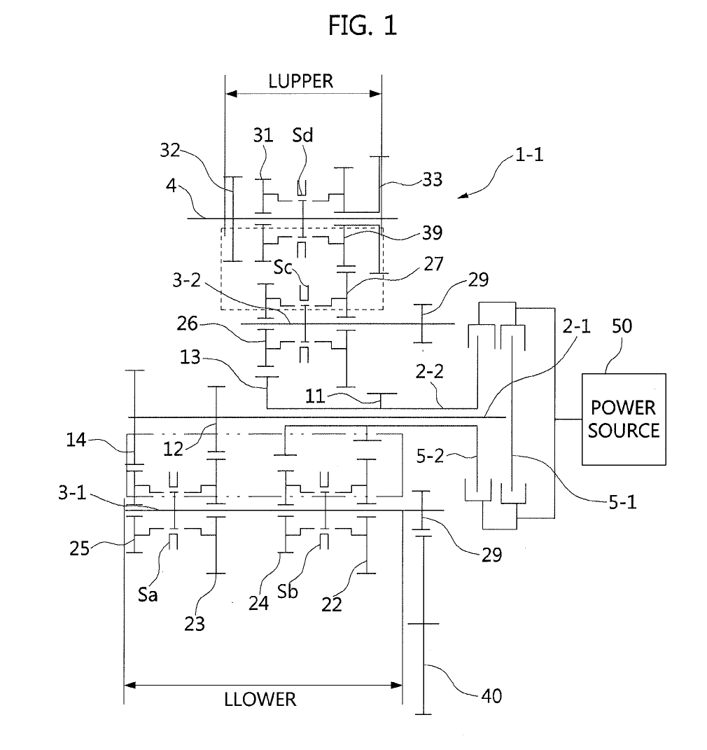

FIG. 1 to FIG. 5 illustrates an exemplary embodiment of a first type six-speed DCT 1-1.

Referring to FIG. 1, the first type six-speed DCT 1-1 includes two input shafts 2-1 and 2-2, two output shafts 3-1 and 3-2, an idler shaft 4, two clutches 5-1 and 5-2, six drive gears 11, 12, 13, 14, 29 and 39, six driven gears 22, 23, 24, 25, 26 and 27 for second to sixth and reverse speed gear stages, three idler gears 31, 32 and 33, one differential gear 40, and one power source 50. The whole length of the DCT is formed by a lower whole length section L_{lower} in a lower region, based on the two input shafts 2-1 and 2-2, and an upper whole length section Lᵤₚₚₑᵣ which is formed in an upper region.

In detail, the two input shafts 2-1 and 2-2 are divided into a first input shaft 2-1 and a second input shaft 2-2. The second shaft 2-2 is formed of a hollow shaft, and the first input shaft 2-1 is disposed into the second shaft 2-2. Among the drive gears, four drive gears including second- to sixth-speed drive gears 11, 12, 13 and 14 are coupled to the second input shaft 2-2. The two output shafts 3-1 and 3-2 are divided into a first output shaft 3-1 and a second output shaft 3-2. The two output shafts 3-1 and 3-2 are coupled with the six driven gears 22, 23, 24, 25, 26 and 27 to transmit output power to the differential gear 40 through the differential drive gear 29 among the drive gears while second to sixth-speed and reverse gear shifting operations are performed. The idler shaft 4 is coupled with the three idler gears 31, 32 and 33 and coupled with a reverse driven gear 27 through a reverse drive gear 39 among the drive gears. The two clutches 5-1 and 5-2 include a first clutch 5-1 which transmits power from the power source 50 to the first input shaft 2-1 or interrupts the transmission of power, and a second clutch 5-2 which transmits power from the power source 50 to the second input shaft 2-2 or interrupts the transmission of power. Particularly, the first and second clutches 5-1 and 5-2 are connected to a clutch actuator. Any one type of hydraulic, pneumatic, motor clutch actuators is used as the clutch actuator.

In detail, the drive gears 11, 12, 13, 14, 29 and 39 include the second drive gear 12 for third speed and the fourth drive gear 14 for fifth speed which are coupled to the first input shaft 2-1, the first drive gear 11 for second speed and the third drive gear 13 for fourth to sixth speed which are coupled to the second input shaft 2-2, the differential drive gear 29 which is coupled to the first and second output shafts 3-1 and 3-2, and the reverse drive gear 39 which is coupled to a third idler gear 33 of the idler shaft 4. The third drive gear 13 embodies fourth speed and sixth speed. Therefore, the first to fourth drive gears 11, 12, 13 and 14, the differential drive gear 29 and the reverse drive gear 39 are called the drive gears. Furthermore, the differential drive gear 29 is also called a final gear. Hereinafter, the first drive gear 11 will be called a second-speed drive gear 11, the second drive gear 12 will be called a third-speed drive gear 12, the third drive gear 13 will be called a fourth- and sixth-speed drive gear 13, and the fourth drive gear 14 will be called a fifth-speed drive gear 14.

In detail, with regard to the driven gears 22, 23, 24, 25, 26 and 27, the second-speed driven gear 22, the third-speed driven gear 23, the fourth-speed driven gear 24, the fifth-speed driven gear 25, and the differential drive gear 29 are coupled to the first output shaft 3-1. The sixth-speed driven gear 26, the reverse driven gear 27, and another differential drive gear 29 which has the same function are coupled to the second output shaft 3-2. Furthermore, a third- and fifth-speed gear shifting device Sa is disposed between the third-speed driven gear 23 and the fifth-speed driven gear 25. A second- and fourth-speed gear shifting device Sb is disposed between the second-speed driven gear 22 and the fourth-speed driven gear 24. A sixth-speed and reverse gear shifting device Sc is disposed between the sixth-speed driven gear 26 and the reverse driven gear 27. Therefore, the whole length of the second output shaft 3-2 is reduced to that of an area occupied by the sixth-speed driven gear 26 and the rear-speed driven gear 27. Consequently, the first type six-speed DCT 1-1 forms the whole length with a shortened upper whole length section Lᵤₚₚₑᵣ.

In detail, the idler gears 31, 32 and 33 which are successively disposed include the first idler gear 31, the second idler gear 32 disposed at the left side of the first idler gear 31, and the third idler gear 33 disposed at the right side of the first idler gear 31. The third idler gear 33 is provided with the reverse drive gear 39 coupled to the reverse driven gear 27. A first-speed gear shifting device Sd is disposed between the first idler gear 31 and the third idler gear 33. The first-speed gear shifting device Sd makes the first/second-speed winding path be used through the first, second and third idler gears 31, 32 and 33, thus forming an excellent step ratio. Therefore, the first idler gear 31 functions as a drive gear, and the second and third idler gears 32 and 33 function as driven gears.

In detail, the differential gear 40 receives the output from the first output shaft 3-1 and the second output shaft 3-2 through the differential inter-gear 29 so that the vehicle travels at a gear shift stage. The power source 50 includes two sources: a motor generator and an internal-combustion engine.

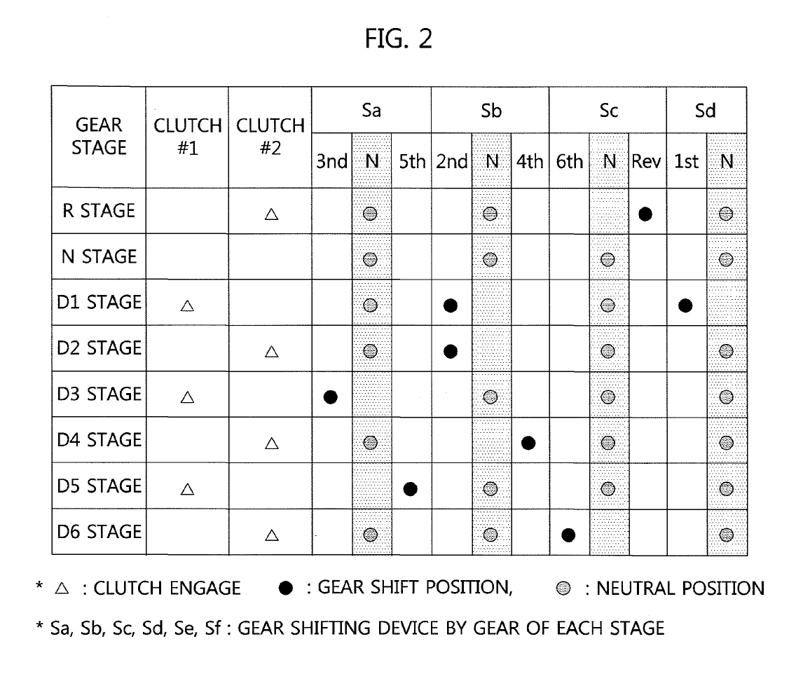

FIG. 2 is a table depicting a gear shifting operation of the first type six-speed DCT 1-1. In the first type six-speed DCT 1-1, the first clutch 5-1 and the second clutch 5-2 pertain to a power source input element from the power source 50. The first input shaft 2-1 and the second input shaft 2-2 pertain to a transmission input element. The first output shaft 3-1, the second output shaft 3-2 and the idler shaft 4 pertain to a transmission output element.

Based on the present, a gear train layout is as follows.

The first input shaft 2-1 is formed of a solid shaft, and the second input shaft 2-2 is formed of a hollow shaft. The first and second input shafts 2-1 and 2-2 are coaxially disposed. The first input shaft 2-1 is selectively coupled with the power source input element through the first clutch 5-1. The second input shaft 2-2 is selectively coupled with the power source input element through the second clutch 5-2. The second-speed drive gear 11, the third-speed drive gear 12, the fourth- and sixth-speed drive gears 13, and the fifth-speed drive gear 14 are disposed on the first input shaft 2-1 and the second input shaft 2-2.

The second-speed driven gear 22, the third-speed driven gear 23, the fourth-speed driven gear 24 and the fifth-speed driven gear 25 are disposed on the first output shaft 3-1. The sixth-speed driven gear 26 and the reverse driven gear 27 are disposed on the second output shaft 3-2. Continuously-connected gear pairs are formed by external engagement between the second-speed drive gear 11 and the second-speed driven gear 22, external engagement between the third-speed drive gear 12 and the third-speed driven gear 23, external engagement between the fourth- and sixth-speed drive gear 13 and the fourth-speed and sixth-speed driven gears 24 and 26, and external engagement between the fifth-speed drive gear 14 and the fifth-speed driven gear 25. The continuously-connected gear pairs transmit the drive force from the power source input element to the drive shaft of the vehicle through the third- and fifth-speed, second- and fourth-speed, and sixth-speed and reverse gear shifting devices Sa, Sb and Sc, thus embodying a forward gear shift stage. In the present case, the forward gear shift stage includes second speed to sixth speed.

The third-speed drive gear 12 disposed on the first input shaft 2-1 and the second idler gear 32 disposed on the idler shaft 4 externally engage with each other, thus forming a continuously-connected gear pair. The second idler gear 32 is selectively coupled with the first idler gear 31 disposed on the idler shaft 4 through the first-speed gear shifting device Sd between the first idler gear 31 and the third idler gear 33. The first idler gear 31 is continuously-connected to the fourth- and sixth-speed drive gear 13 disposed on the second input shaft 2-2 by external engagement therebetween, thus forming a continuously-connected gear pair. The first idler gear 31 transmits drive force from the second-speed drive gear 11 disposed on the second input shaft 2-2 to the drive shaft of the vehicle, thus embodying a forward gear shift stage. In the present case, the forward gear shift stage refers to first speed.

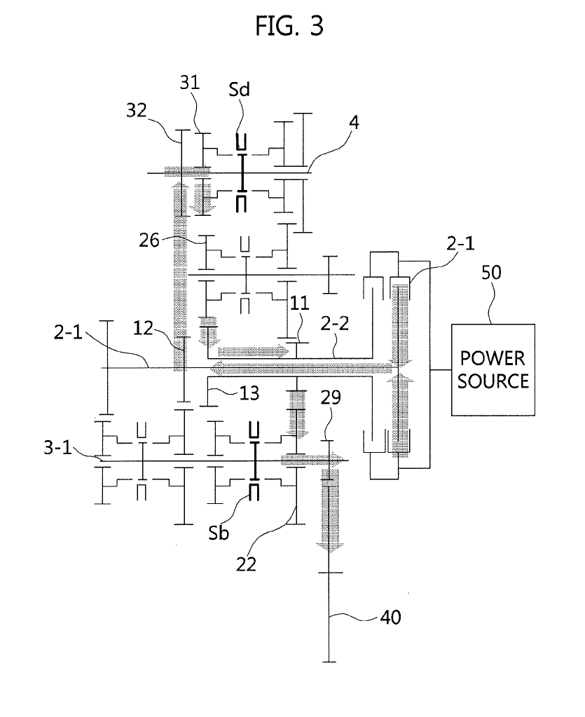

FIG. 3 to FIG. 5 illustrates a gear shifting operation of the first type six-speed DCT 1-1.

FIG. 3 illustrates an example of a power transmission path of the first-speed gear shifting operation. The flow of the first-speed forward power transmission is formed in a sequence of the first clutch 5-1→the third-speed drive gear 12 of the first input shaft 2-1→the second idler gear 32 of the idler shaft 4→the first-speed gear shifting device Sd→the first idler gear 31 of the idler shaft 4→the fourth- and sixth-speed drive gear 13 of the second input shaft 2-2→the second-speed drive gear 11 of the second input shaft 2-2→the second-speed driven gear 22 of the first output shaft 3-1→the second- and fourth-speed gear shifting device Sb→the differential drive gear 29 (or the final gear) of the first output shaft 3-1→the differential gear 40. Here, the symbol “→” denotes the direction of the power transmission path.

Therefore, to embody the first gear stage the third-speed driven gear 23 and the second idler gear 32 function as the first-speed driven gears, the first idler gear 31 functions as the first-speed drive gear, and the second- and fourth-speed gear shifting device Sb is used as a synchro device. Thus, the second input shaft 2-2 that is a hollow shaft and the first input shaft 2-1 that is a solid shaft are rotated in the same direction, whereby a drag loss can be reduced.

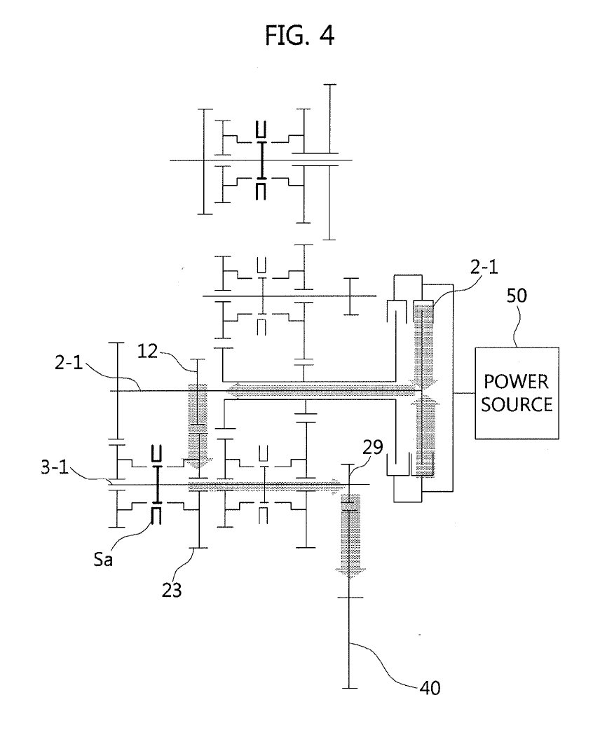

FIG. 4 illustrates an example of a power transmission path of the third-speed gear shifting operation. The flow of the third-speed forward power transmission is formed in a sequence of the first clutch 5-1→the third-speed drive gear 12 of the first input shaft 2-1→the third-speed driven gear 23 of the first output shaft 3-1→the second idler gear 32 of the idler shaft 4→the third-speed gear shifting device Sa→the differential drive gear 29 (or the final gear) of the first output shaft 3-1→the differential gear 40. Here, the symbol “→” denotes the direction of the power transmission path.

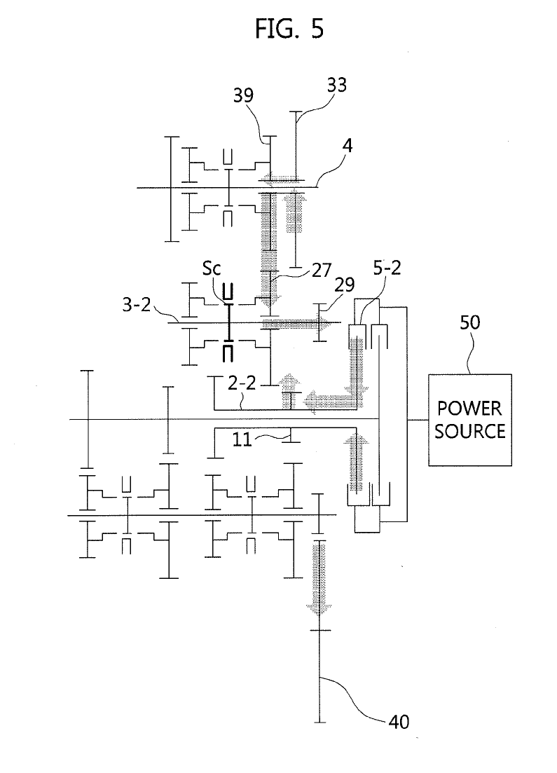

FIG. 5 illustrates an example of a power transmission path of the reverse gear shifting operation. The flow of the reverse power transmission is formed in a sequence of the second clutch 5-2→the second-speed drive gear 11 of the second input shaft 2-2→the third idler gear 33 and the reverse drive gear 39 of the idler shaft 4→the reverse driven gear 27 of the second output shaft 3-2→the sixth-speed and reverse gear shifting device Sc→the differential drive gear 29 (or the final gear) of the second output shaft 3-2→the differential gear 40. Here, the symbol “→” denotes the direction of the power transmission path.

Therefore, when the vehicle moves backward the second-speed drive gear 11 is used as a common gear, the third idler gear 32 is used as a reverse driven gear, the reverse drive gear 39 is used as a reverse drive gear, and the sixth-speed and reverse gear shifting device Sc is used as a synchro device, whereby the reverse gear stage is embodied.

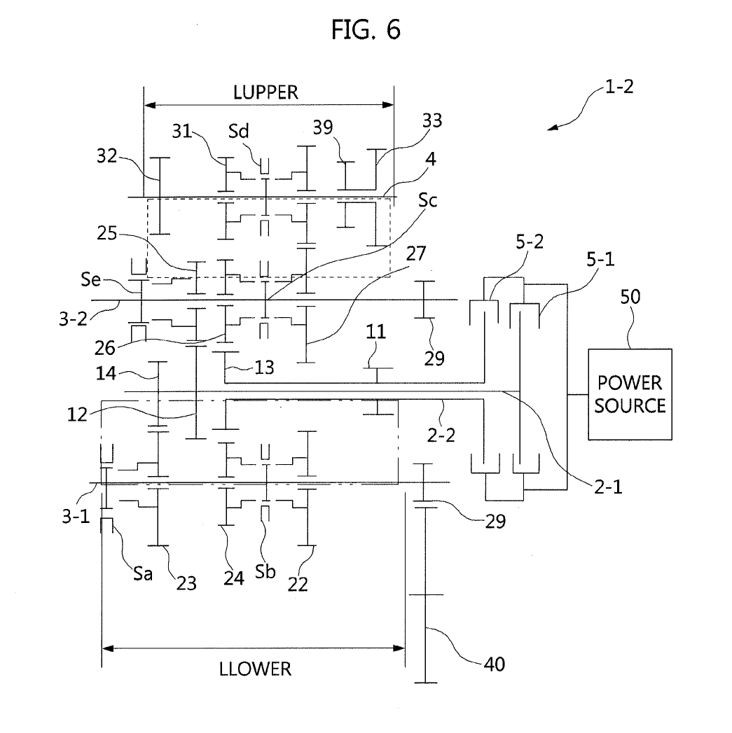

FIG. 6 to FIG. 10 illustrates an example of a second type six-speed DCT 1-2.

Referring to FIG. 6, the second type six-speed DCT 1-2 includes two input shafts 2-1 and 2-2 which are divided into a first input shaft 2-1 which is solid and a second input shaft 2-2 which is hollow, two output shafts 3-1 and 3-2 divided into a first output shaft 3-1 and a second output shaft 3-2, one idler shaft 4, two clutches 5-1 and 5-2 divided into a first clutch 5-1 and a second clutch 5-2, six drive gears 11, 12, 13, 14, 29 and 39, six driven gears 22, 23, 24, 25, 26 and 27 for second- to sixth-speed and reverse gear stages, three idler gears 31, 32 and 33, one differential gear 40 and one power source 50. The whole length of the DCT is formed by a lower whole length section L_{lower} which is formed in a lower region, based on the two input shafts 2-1 and 2-2, and an upper whole length section Lᵤₚₚₑᵣ which is formed in an upper region.

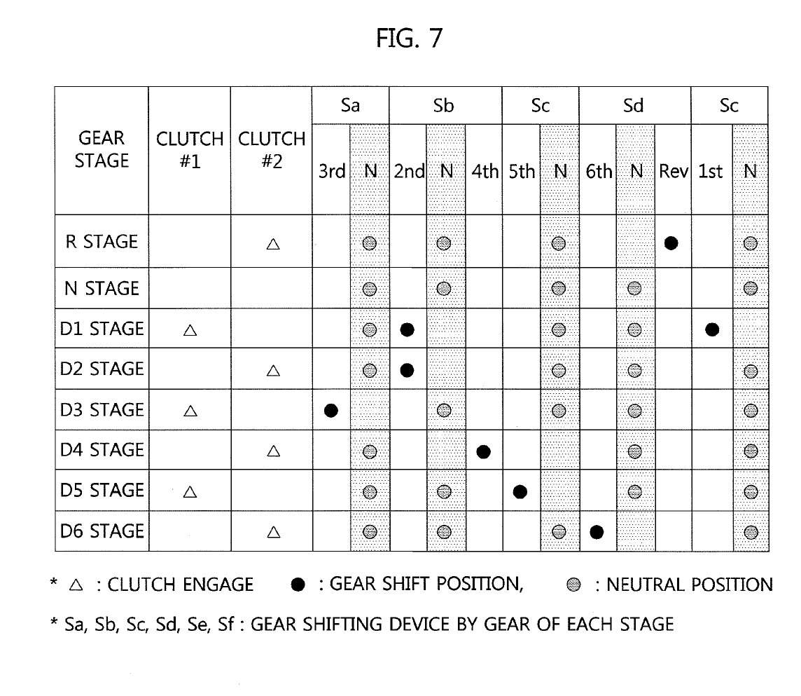

Accordingly, the second type six-speed DCT 1-2 has the same configuration elements as those of the first type six-speed DCT 1-1 described with reference to FIG. 1. However, the second type six-speed DCT 1-2 has a different gear pair combination of the first to fourth drive gears 11, 12, 13 and 14 and the second- to sixth-speed and reverse driven gears 22, 23, 24, 25, 26 and 27 from that of the first type six-speed DCT 1-1. A gear train layout for a gear shifting operation of the second type six-speed DCT 1-2 is embodied as shown in the table of FIG. 7, illustrating the gear shifting operation and is different from the gear train layout of the first type six-speed DCT 1-1.

Referring to FIG. 7 in detail, the first drive gear 11 externally engages with the second-speed driven gear 22 to form a gear pair. The second drive gear 12 externally engages with the fifth-speed driven gear 25 to form a gear pair. The third drive gear 13 externally engages with a fourth and sixth-speed driven gear 24 and 26 respectively to form a gear pair. The fourth drive gear 14 externally engages with the third-speed driven gear 23 to form a gear pair. Therefore, the first drive gear 11 functions as the second-speed drive gear 11, the second drive gear 12 functions as the fifth-speed drive gear 12, the third drive gear 13 functions a fourth- and sixth-speed drive gear 13, and the fourth drive gear 14 functions as the third-speed drive gear 14. Therefore, the second type six-speed DCT 1-2 has a difference from the first type six-speed DCT 1-1 in which the second drive gear 12 functions as the third-speed drive gear 12 and the fourth drive gear 14 functions as the fifth-speed drive gear 14.

In detail, the second-speed driven gear 22, the third-speed driven gear 23 and the fourth-speed driven gear 24 are coupled to the first output shaft 3-1. The fifth-speed driven gear 25, the sixth-speed driven gear 26 and the reverse driven gear 27 are coupled to the second output shaft 3-2. Furthermore, a third-speed gear shifting device Sa is disposed on the third-speed driven gear 23. A second- and fourth-speed gear shifting device Sb is disposed between the second-speed driven gear 22 and the fourth-speed driven gear 24. A sixth-speed and reverse gear shifting device Sc is disposed between the sixth-speed driven gear 26 and the reverse driven gear 27. A first-speed gear shifting device Sd is disposed between the first idler gear 31 and the third idler gear 33. A fifth-speed gear shifting device Se is disposed on the fifth-speed driven gear 25. Therefore, there is a difference between the first and second type six-speed DCTs 1-1 and 1-2 in that the second type six-speed DCT 1-2 has the five gear shifting devices. Consequently, the whole length of the first input shaft 2-1 is reduced by the area occupied by the fifth-speed driven gear 25, whereby the second type six-speed DCT 1-2 forms the whole length with a shortened distance between the lower whole length section L_{lower} and the upper whole length section Lᵤₚₚₑᵣ.

In detail, the third-speed drive gear 14 disposed on the first input shaft 2-1 and the second idler gear 32 disposed on the idler shaft 4 externally engage with each other, thus forming a continuously-connected gear pair. As a result, the second type six-speed DCT 1-2 has a difference from the first type six-speed DCT 1-1 in which the third-speed drive gear 12 disposed on the first input shaft 2-1 and the second idler gear 32 disposed on the idler shaft 4 externally engage with each other and thus form a continuously-connected gear pair.

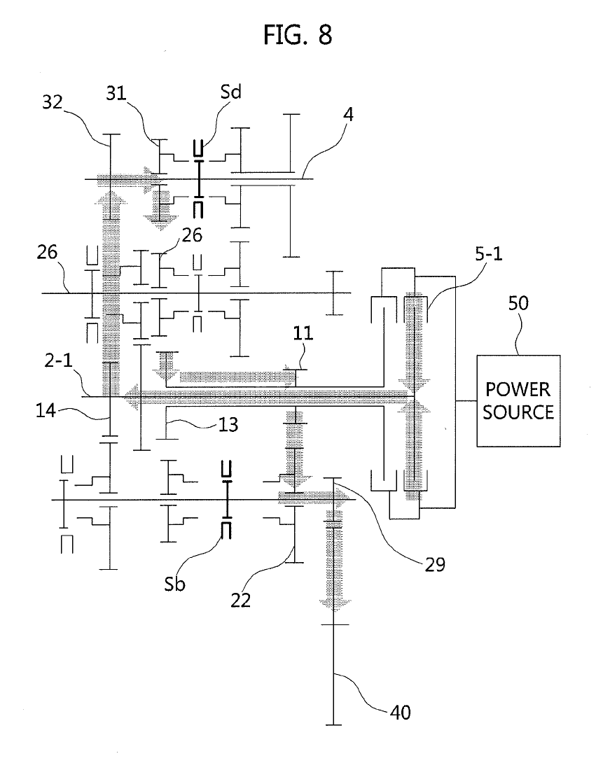

FIG. 8 to FIG. 10 illustrates a gear shifting operation of the second type six-speed DCT 1-2.

FIG. 8 illustrates an example of a power transmission path of a first-speed gear shifting operation. The flow of the first-speed forward power transmission is formed in a sequence of the first clutch 5-1→the third-speed drive gear 14 of the first input shaft 2-1→the second idler gear 32 of the idler shaft 4→the first-speed gear shifting device Sd→the first idler gear 31 of the idler shaft 4→the fourth- and sixth-speed drive gear 13 of the second input shaft 2-2→the second-speed drive gear 11 of the second input shaft 2-2→the second-speed driven gear 22 of the first output shaft 3-1→the second- and fourth-speed gear shifting device Sb→the differential drive gear 29 (or the final gear) of the first output shaft 3-1→the differential gear 40. Here, the symbol “→” denotes the direction of the power transmission path.

Therefore, to embody the first gear stage, the third-speed driven gear 14 and the second idler gear 32 function as the first-speed driven gears, the first idler gear 31 functions as the first-speed drive gear, and the second- and fourth-speed gear shifting device Sb is used as a synchro device. Accordingly, the second input shaft 2-2 that is a hollow shaft and the first input shaft 2-1 that is a solid shaft are rotated in the same direction, whereby a drag loss can be reduced.

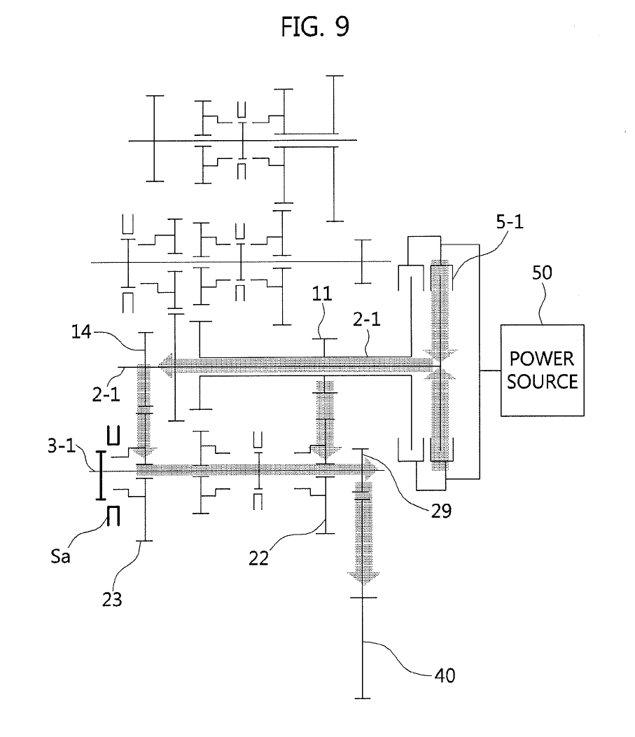

FIG. 9 illustrates an example of a power transmission path of the third-speed gear shifting operation. The flow of the third-speed forward power transmission is formed in a sequence of the first clutch 5-1→the third-speed drive gear 14 of the first input shaft 2-1→the third-speed driven gear 23 of the first output shaft 3-1→the third-speed gear shifting device Sa→the differential drive gear 29 (or the final gear) of the first output shaft 3-1→the differential gear 40. Here, the symbol “→” denotes the direction of the power transmission path.

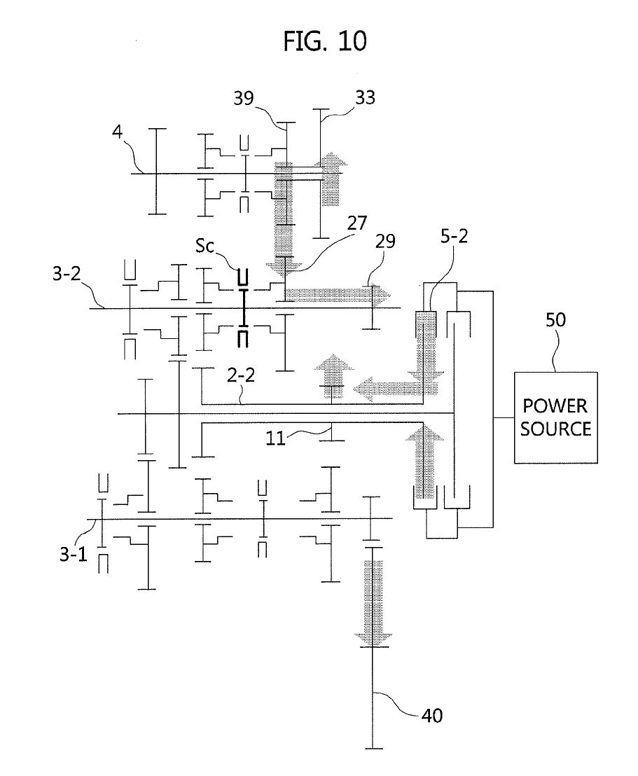

FIG. 10 illustrates an example of a power transmission path of the reverse gear shifting operation. The flow of the reverse power transmission is formed in a sequence of the second clutch 5-2→the second-speed drive gear 11 of the second input shaft 2-2→the third idler gear 33 and the reverse drive gear 39 of the idler shaft 4→the reverse driven gear 27 of the second output shaft 3-2→the sixth-speed and reverse gear shifting device Sc→the differential drive gear 29 (or the final gear) of the second output shaft 3-2→the differential gear 40. Here, the symbol “→” denotes the direction of the power transmission path.

Therefore, when the vehicle moves backward, the second-speed drive gear 11 is used as a common gear, the third idler gear 32 is used as a reverse driven gear, the reverse drive gear 39 is used as a reverse drive gear, and the sixth-speed and reverse gear shifting device Sc is used as a synchro device, whereby the reverse gear stage is embodied.

Comparing FIG. 1 with FIG. 6, it can be understood that the six-speed DCT not only has the same step ratio improvement effect, but a length-reduced portion of the DCT is also changed by altering the gear train layout.

In detail, in the first type six-speed DCT 1-1 of FIG. 1, only the six-speed driven gear 26 is disposed on the second output shaft 3-2, so that the upper whole length section Lᵤₚₚₑᵣ is reduced by a reduced whole length of the second output shaft 3-2, whereby the whole length of the DCT can be reduced. As a result, in the case of the first type six-speed DCT 1-1, even when the length of a motor for in the application of a hybrid structure is added, the extra area of the upper whole length section Lᵤₚₚₑᵣ can be used, ease of disposition can be realized. Furthermore, in the second type six-speed DCT 1-2 of FIG. 6, because the shaft whole length is reduced by the area occupied by the fifth-speed driven gear 25, the second type six-speed DCT 1-2 forms a whole length with a reduced intermediate whole length section formed between the lower whole length section L_{lower} and the upper whole length section Lᵤₚₚₑᵣ. As a result, in the case of the first type six-speed DCT 2-2, even when the length of a motor for application of a hybrid structure is added, the extra area of the intermediate whole length section can be used, ease of disposition can be realized.

As described above, the six-speed DCT 1-1 according to an exemplary embodiment of the present invention includes the two first and second input shafts 2-1 and 2-2 on which the four drive gears 11, 12, 13 and 14 are disposed, the single idler shaft 4 on which the three idler drive gears 31, 32 and 33 are arranged, and the two first and second output shafts 3-1 and 3-2 on which the six driven gears 22, 23, 24, 25, 26 and 27 for forward six speeds and reverse speed are disposed. The whole length of the DCT is formed such that the upper whole length section Lᵤₚₚₑᵣ is reduced by the whole length of the second output shaft 3-2; reduced by disposing the sixth-speed and reverse driven gears 26 and 27 on the second output shaft 3-2, or the intermediate whole length section formed between the upper whole length section Lᵤₚₚₑᵣ and the lower whole length section L_{lower} is reduced by the whole length of the first input shaft 2-1 that is reduced by disposing the fifth-, sixth- and reverse driven gears 25, 26 and 27 on the second output shaft 3-2. Therefore, a reduction in the size of the six-speed DCT 1-1 can be realized even when the length of the motor for application of a hybrid structure is added, whereby ease of disposition can be realized.

As described above, a six-speed DCT according to an exemplary embodiment of the present invention is configured to reduce the whole length of the DCT compared to that of the conventional six-speed small DCT. Therefore, not only can ease of disposition of the DCT in a small vehicle be improved, but ease of disposition of the DCT in a hybrid vehicle in which the length of a motor must be added can also be greatly improved. The six-speed DCT according to an exemplary embodiment of the present invention has an excellent step ratio compared to that of the conventional six-speed small DCT, thus reducing influence of the step ratio on the drivability.

Furthermore, the six-speed DCT according to an exemplary embodiment of the present invention employs three combined idler gears in improving the step ratio and reducing the whole length of the DCT, whereby a gear train layout can be formed without a first-speed gear.

In addition, in the six-speed DCT according to an exemplary embodiment of the present invention, gear shifting from first speed to second speed or from first speed to reverse can be smoothly performed.

For convenience in explanation and accurate definition in the appended claims, the terms “upper”, “lower”, “internal”, “outer”, “up”, “down”, “upwards”, “downwards”, “front”, “rear”, “back”, “inside”, “outside”, “inwardly”, “outwardly”, “internal”, “external”, “forwards” and “backwards’ are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A six-speed double clutch transmission including an input element from a power source, a first clutch and a second clutch, a first input shaft and a second input shaft each functioning as an input element of the transmission, and a first output shaft, a second output shaft and an idler shaft each functioning as an output element of the transmission,
wherein the first input shaft and the second input shaft are coaxially disposed, the first input shaft is selectively coupled to the input element through the first clutch, and the second input shaft is selectively coupled to the input element through the second clutch,
wherein one or more drive gears are disposed on each of the first input shaft and the second input shaft, one or more driven gears are disposed on each of the first output shaft and the second output shaft, and one of the drive gears and a corresponding one of the driven gears are continuously-connected to each other by external engagement to form a gear pair, and transmit drive force of the input element to a drive shaft of a vehicle through a plurality of gear shifting devices, thus embodying a forward gear shift stage, and
wherein one drive gear disposed on the first input shaft externally engages with one driven gear disposed on the idler shaft, thus forming a continuously-connected gear pair, the one driven gear is selectively coupled to one or more drive gears disposed on the idler shaft through a separate gear shifting device, one drive gear disposed on the idler shaft externally engages with one drive gear disposed on the second input shaft, thus forming a continuously-connected gear pair, and drive force from another drive gear disposed on the second input shaft is transmitted to the drive shaft of the vehicle, thus embodying another forward gear shift stage.

2. The six-speed double clutch transmission of claim 1, wherein the first input shaft is a solid shaft, and the second input shaft is a hollow shaft.

3. The six-speed double clutch transmission of claim 1,
wherein the drive gears of the first input shaft and the second input shaft comprise a second-speed drive gear, a third-speed drive gear, a fourth- and sixth-speed drive gear, and a fifth-speed drive gear,
wherein the driven gears of the first output shaft and the second output shaft comprise a second-speed driven gear, a third-speed driven gear, a fourth-speed driven gear, a fifth-speed driven gear, a sixth-speed driven gear, and a reverse driven gear,
wherein the driven gear on the idler shaft includes a second idler gear, and the drive gears on the idler shaft comprise a first idler gear and a third idler gear, and
wherein the gear shifting devices comprise a third- and fifth-speed gear shifting device, a two- and fourth-speed gear shifting device, a sixth- and reverse gear shifting device, and a first-speed gear shifting device.

4. The six-speed double clutch transmission of claim 3, wherein the second-speed driven gear, the third-speed driven gear, the fourth-speed driven gear and the fifth-speed driven gear are disposed on the first output shaft, the sixth-speed driven gear and the reverse driven gear are disposed on the second output shaft, and the continuously-connected gear pairs comprise the second-speed drive gear and the second-speed driven gear, the third-speed drive gear and the third-speed driven gear, the fourth- and sixth-speed drive gear and the fourth- and sixth-speed driven gear, the fifth-speed drive gear and the fifth-speed driven gear, the fourth- and sixth-speed drive gear and the first idler gear, and the third-speed drive gear and the second idler gear.

5. The six-speed double clutch transmission of claim 3, wherein the third- and fifth-speed gear shifting device selectively connects the third-speed driven gear, the second- and fourth-speed gear shifting device selectively connects the second-speed driven gear, and the sixth-speed and reverse gear shifting device selectively connects the reverse driven gear.

6. The six-speed double clutch transmission of claim 3, wherein the first-speed gear shifting device selectively connects the second idler gear with the first idler gear.

7. The six-speed double clutch transmission of claim 1,
wherein the drive gears of the first input shaft and the second input shaft comprise a second-speed drive gear, a third-speed drive gear, a fourth- and sixth-speed drive gear, and a fifth-speed drive gear,
wherein the driven gears of the first output shaft and the second output shaft comprise a second-speed driven gear, a third-speed driven gear, a fourth-speed driven gear, a fifth-speed driven gear, a sixth-speed driven gear, and a reverse driven gear,
wherein the driven gear on the idler shaft includes a second idler gear, and the drive gears on the idler shaft comprise a first idler gear and a third idler gear, and
wherein the gear shifting devices comprise a third-speed gear shifting device, a two- and fourth-speed gear shifting device, a sixth-speed and reverse gear shifting device, a first-speed gear shifting device, and a fifth-speed gear shifting device.

8. The six-speed double clutch transmission of claim 7, wherein the second-speed driven gear, the third-speed driven gear and the fourth-speed driven gear are disposed on the first output shaft, the fifth-speed driven gear, the sixth-speed driven gear and the reverse driven gear are disposed on the second output shaft, and the continuously-connected gear pairs comprise the second-speed drive gear and the second-speed driven gear, the third-speed drive gear and the third-speed driven gear, the fourth- and sixth-speed drive gear and the fourth- and sixth-speed driven gear, the fifth-speed drive gear and the fifth-speed driven gear, the fourth- and sixth-speed drive gear and the first idler gear, and the third-speed drive gear and the second idler gear.

9. The six-speed double clutch transmission of claim 7, wherein the third-speed gear shifting device selectively connects the third-speed driven gear, the second- and fourth-speed gear shifting device selectively connects the second-speed driven gear, the sixth-speed and reverse gear shifting device selectively connects the reverse driven gear, and the fifth-speed gear shifting device selectively connects the fifth-speed driven gear.

10. The six-speed double clutch transmission of claim 7, wherein the first-speed gear shifting device selectively connects the second idler gear with the first idler gear.

11. The six-speed double clutch transmission of claim 1, wherein the power source includes a motor generator.
